(19) United States
(12) Patent Application Publication
(10) Pub. No.: US 2005/0289012 A1
(43) Pub. Date: Dec. 29, 2005

(54) Distribution and marketing system and method for subscription service

(76) Inventor: Richard Boller, Hermitage, MO (US)

Correspondence Address: HUSCH & EPPENBERGER, LLC, 190 CARONDELET PLAZA, SUITE 600, ST. LOUIS, MO, 63105-3441, US

(21) Appl. No.: 10/878,748

(22) Filed: Jun. 28, 2004

(51) Int. Cl. G06F 17/60

(52) U.S. Cl. 705/26

(57) ABSTRACT

A distribution system for a subscription service includes a provider of the subscription service, wherein the subscription service has at least one subject matter theme; a distribution network for the subscription service, wherein said distribution system comprises at least one central source at said provider and a plurality of receiving points; and a receiving device for the subscription service, wherein the subscription service is provided to said receiving device through said distribution network and wherein said receiving device comprises a design corresponding to said at least one subject matter theme.

### TECHNICAL FIELD OF THE INVENTION

The present invention relates generally to the marketing and distribution of subscription-based services and, more particularly, to an improved distribution and marketing system and method for subscription-based services.

### BACKGROUND OF THE INVENTION

Entertainment services have utilized the concept of subscriptions as the basic means of distribution for years. This includes subscriptions for newspapers, magazines, or, more recently, television and internet programming. In any subscription-based service, the primary goal is to entice larger and larger numbers of new subscribers to the service. This is essential to not only grow the subscription base, but to replace other subscribers as they discontinue service. Among the difficulties presented in doing so is the crowded nature of many of these entertainment arenas. There are an immense range and number of magazines, newspapers, television packages, and internet web sites, all of which are competing to put themselves in the forefront of the consciousness of potential subscribers.

A number of methods have been utilized to distribute and promote entertainment services and make a particular provider's services stand out from its competitors. Most of these methods center on the nature of the provider's particular packages and limited-time offers of promotional pricing. Another promotional method commonly used is the concept of a free gift offered to new service subscribers. While these methods are widely used among the various entertainment media, they all fail to fully tap into the possibilities created by satellite, internet, and wireless based services.

The present invention is directed to addressing one or more of the identified problems and needs set forth above.

### SUMMARY OF THE INVENTION

An aspect of the present invention is to provide an improved method of marketing subscription-based services.

Another aspect of the present invention is to provide an improved distribution system for subscription-based multi-media programs.

In accordance with the above aspect of the invention, there is provided a distribution system for a subscription service comprising a provider of the subscription service, wherein the subscription service has at least one subject matter theme; a distribution network for the subscription service, wherein said distribution system comprises at least one central source at said provider and a plurality of receiving points; and a receiving device for the subscription service, wherein the subscription service is provided to said receiving device through said distribution network and wherein said receiving device comprises a design corresponding to said at least one subject matter theme.

There is also provided a distribution system for a plurality of multi-media programs comprising a broadcaster of the multi-media programs, wherein a first set of the multi-media programs is available under a first subscription service with a first subject matter theme and a second set of the multi-media programs is available under a second subscription service with a second subject matter theme; a satellite network for distributing the multi-media programs, wherein said distribution system comprises at least one uplink site for said broadcaster and a downlink footprint, said downlink footprint comprising a geographic area with a plurality of receiving locations; and a satellite antenna within said downlink footprint for receiving the multi-media programs, wherein said subscription service is provided to said receiving device through said distribution network wherein and said satellite antenna comprises a design corresponding to one of said first subject matter theme and said second subject matter theme.

There is also provided a method for marketing satellite broadcast services comprising providing a set of multi-media programs, wherein a first set of the multi-media programs is available under a basic subscription service with a set of standard subject matter themes and a premier set of the multi-media programs is available under an optional subscription service with at least one specialty subject matter theme, said specialty subject matter theme comprising at least one of a sports theme, a movie theme, a music theme, and a gaming theme; offering said premier subscription service to a set of subscribers in combination with a corresponding set of satellite antennas, wherein said satellite antennas comprise a set of designs corresponding to at least one of said specialty subject matter themes; said set of designs comprising at least one of a set of team logos for said sports theme, a set of movie screen-shots for said movie theme, a set of band logos for said music theme, and a set of gaming logos for said gaming theme; receiving a set of subscription selections from said set of subscribers for said premier subscription service and a corresponding selection of said set of designs; and providing said premier subscription service subscribers with a set of satellite antennas with said corresponding set of selected designs.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 illustrates a block diagram of a distribution system according to one embodiment of the present invention.

FIG. 2 is a schematic view of a satellite antenna with a design corresponding to sports themed programming suitable for use in a distribution system or marketing method as outlined herein.

FIG. 3 is a schematic view of a satellite antenna with a design corresponding to movie themed programming suitable for use in a distribution system or marketing method as outlined herein.

FIG. 4 is a schematic view of a satellite antenna with a design corresponding to music themed programming suitable for use in a distribution system or marketing method as outlined herein.

FIG. 5 is a schematic view of a satellite antenna with a design corresponding to gaming themed programming suitable for use in a distribution system or marketing method as outlined herein.

FIG. 6 is a flow chart of a distribution system or marketing method as outlined herein.

### DETAILED DESCRIPTION

Multi-media program distribution concepts generally include a broadcast point 12, a receiving point 14, and a distribution network 16 to transmit the multi-media programming from the broadcast point 12 to the receiving point 14. The forms that these items take vary with the particular technology format for which the multi-media programming is intended. In the simplest case of over-the-air television programming, the broadcast point 12 and distribution network 16 may consist of a transmitting antenna associated with a studio, while the receiving point 14 consists of an antenna associated with a television set. With a standard cable television system, the broadcast point 12 might be considered to be the receiving station of the local cable system, which is itself also a receiving point for programming from various broadcast points, while the distribution network 16 is the cable network in the area running to residences in the area. With internet based services, a centralized server is the broadcast point 12, the internet serves as the distribution network 16, and the receiving point 14 is the subscriber's modem or computer terminal.

In the case of direct satellite systems, such as DirectTV®, DISH Network® or VOOM®, the broadcast point 12 is formed by the particular system's centralized broadcast station, which is alternately referred to as an uplink site, while the distribution network 16 is composed of at least one satellite. The satellite is generally stationed in geosynchronous orbit over the intended broadcast area. The broadcast area is also referred to as a downlink footprint consisting of a geographic area having a number of receiving points 14. Individual satellite antennas that are provided to each subscribing household form the receiving points 14.

The satellite antennas utilized with most direct satellite systems are generally very similar and have two primary components: a parabolic reflecting surface and a receiving horn. The parabolic reflecting surface is arranged to focus the incoming satellite signal, regardless of its exact direction, at the receiving horn.

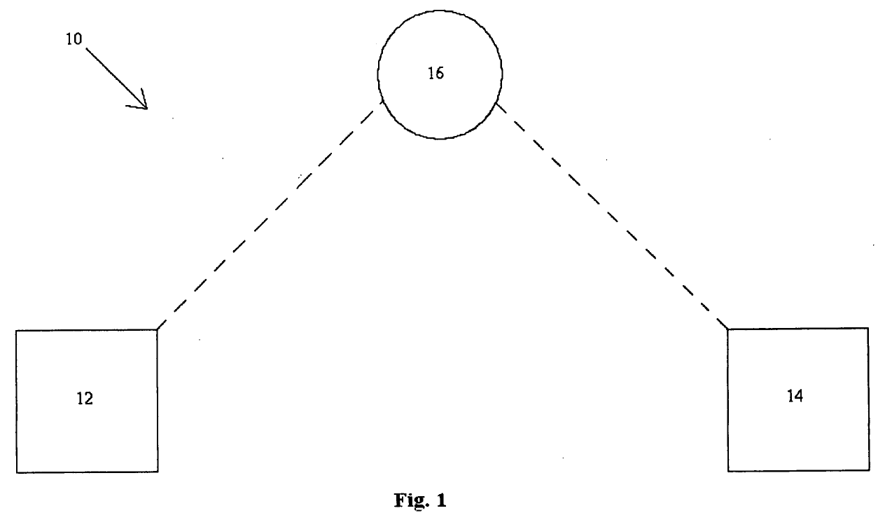

FIG. 1 illustrates a distribution system 10 for multi-media programming according to one embodiment of the present invention. The distribution system includes a broadcast point 12, a receiving point 14, and a distribution network 16 connecting the two. The multi-media programming is preferably subscription-based 30 and may be comprised of two programming tiers or sets of different channels, in the case of satellite television. The programming tiers are preferably arranged around various themes 32. For example, one programming tier may consist of premium sports channels, while another consists of movie channels. Other possible themes include tiers geared towards outdoor activities, music, gaming, crafts, etc. It will be apparent to those skilled in the art that the possible themes suitable for use in the present distribution system and marketing method are not limited to those enumerated herein.

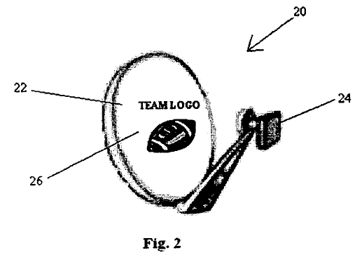

The distribution system 10 also includes the use of a receiving point 16 with a specific tie-in to the theme of one of the provider's programming tiers 34. In particular, the receiving point 16 is provided with a design that corresponds to the theme of the programming tier. For example, the receiving point 16 might have a sports-related design, such as a league (NFL, NBA, MLB, NASCAR, IRL) or individual team logo. A provider can offer new subscribers a receiving point bearing the logo of their favorite team as an incentive to subscribe to the provider's premium sports channel programming tier. Similarly, a provider might offer a receiving point having a depiction of a duck, hunting dog, or fish for a new subscription to its outdoor programming tier; a screen-shot from the new subscriber's favorite movie with a subscription to the premium movie tier; the logo of the subscriber's favorite band for a music programming tier; or a gaming logo, cards, or dice with a subscription to a gaming programming tier. FIGS. 2 -5 illustrate non-limiting examples of receiving points incorporating designs corresponding to themed programming. A provider can offer a set of different designs within these and similar categories from which a potential new subscriber may choose. This provides the opportunity to entice a new subscriber with an incentive that is specifically geared towards his/her particular interest.

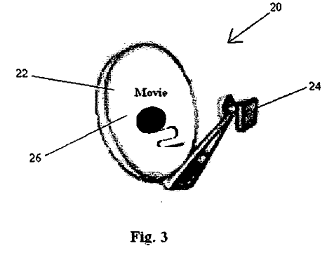

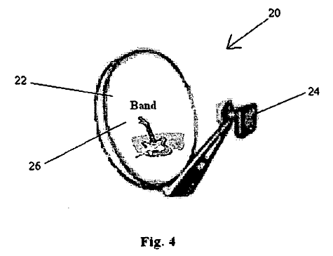

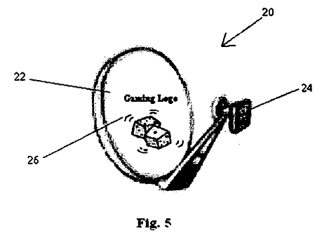

In the case of direct satellite service, the parabolic surface of the satellite antenna provides an ideal surface for the corresponding design. Because the antenna must be located outside the subscriber's home and is therefore visible to passersby, it also provides constant promotion of the provider's programming tiers to other potential subscribers. FIGS. 2-5 illustrate examples of a satellite antenna 20 having a parabolic reflecting surface 22 and receiving horn 24. A design 26 corresponding to a particular programming theme is affixed to the parabolic reflecting surface 22.

In the preferred embodiment, the design is affixed directly and permanently to the parabolic surface of the satellite antenna before the antenna is sent to the new subscriber. In a particularly preferred embodiment, the design is scotch printed or silk screened to the parabolic surface. This provides a permanent and smooth adherence of the design to the surface, thereby rendering the surface easier to clean and making it less prone to accumulation of snow and ice during winter months.

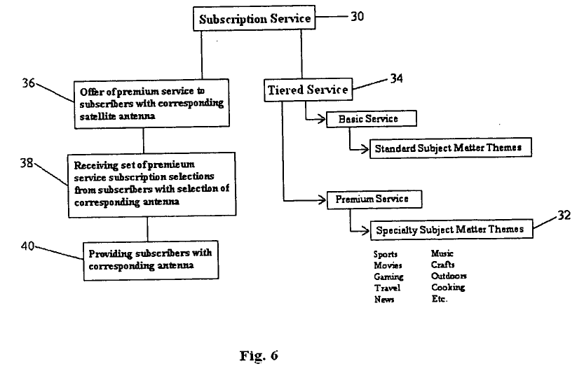

In the corresponding marketing method, illustrated in the flow chart provided in FIG. 6, a programming provider provides 36 a tiered set of multi-media programming 34. The multi-media programming preferably includes a first set of multi-media programs available under a basic subscription service with a set of standard subject matter themes and a premier set of multi-media programs available under an optional subscription service with at least one specialty subject matter theme 32. The specialty subject matter themes may include a sports theme, a movie theme, a music theme, and a gaming theme (although additional themes are readily apparent). The provider then offers 38 the premier subscription service to subscribers in combination with the offer of a satellite antenna that includes a design corresponding to the specialty subject matter theme selected by the subscribers. For example, the designs might include a set of team logos for the sports theme, a set of movie screen-shots for the movie theme, a set of band logos for the music theme, and a set of gaming logos for the gaming theme. Again other possible designs corresponding to other specialty subject matter themes are encompassed within the described method. Finally, the provider provides 40 the new subscribers with an antenna having a design corresponding to the subscriber's selected specialty subject matter theme.

While the preferred embodiment has been described in the context of direct satellite service, it will be apparent to those skilled in the art that the present distribution system and marketing method are suitable for use with other media formats, for example, over-the-air or internet-based subscription services in which a design corresponding to the theme of the particular programming is affixed to a television antenna or a modem provided to new subscribers. The system and method described herein may also be utilized with satellite radio services, such as Sirius® or XM® radio.

Other objects, features and advantages of the present invention will be apparent to those skilled in the art. While preferred embodiments of the present invention have been illustrated and described, this has been by way of illustration and the invention should not be limited except as required by the scope of the appended claims and their equivalents.

In the preceding detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

1. A distribution system for a subscription service, comprising:
a provider of the subscription service, wherein the subscription service has at least one subject matter theme;
a distribution network for the subscription service, wherein said distribution system comprises at least one central source at said provider and a plurality of receiving points; and
a receiving device for the subscription service, wherein the subscription service is provided to said receiving device through said distribution network and wherein said receiving device comprises a design corresponding to said at least one subject matter theme.

2. The distribution system of claim 1, wherein said subscription service comprises multi-media programming.

3. The distribution system of claim 1, wherein said subject matter theme comprises at least one of a sports theme, a movie theme, a music theme, and a gaming theme.

4. The distribution system of claim 3, wherein said design comprises at least one of a team logo, a movie screen-shot, a band logo, and a gaming logo.

5. The distribution system of claim 1, wherein said receiving device comprises a satellite antenna having a parabolic surface.

6. The distribution system of claim 5, wherein said design is located on said parabolic surface.

7. The distribution system of claim 6, wherein said design is applied to said parabolic surface by scotch printing.

8. The distribution system of claim 6, wherein said design is applied to said parabolic surface by silk screening.

9. The distribution system of claim 1, wherein said distribution network comprises at least one satellite.

10. The distribution system of claim 1, wherein said distribution network comprises at least one uplink site and a downlink footprint.

11. The distribution system of claim 10, wherein said receiving device comprises a satellite antenna and wherein said satellite antenna is located within said downlink footprint.

12. The distribution system of claim 1, wherein said distribution network comprises a computer network, said central source comprises a server, and said receiving device comprises a modem.

13. The distribution system of claim 1, wherein said distribution network comprises a transmission tower and said receiving device comprises an antenna.

14. A distribution system for a plurality of multi-media programs, comprising:
a broadcaster of the multi-media programs, wherein a first set of the multi-media programs is available under a first subscription service with a first subject matter theme and a second set of the multi-media programs is available under a second subscription service with a second subject matter theme;
a satellite network for distributing the multi-media programs, wherein said distribution system comprises at least one uplink site for said broadcaster and a downlink footprint, said downlink footprint comprising a geographic area with a plurality of receiving locations; and
a satellite antenna within said downlink footprint for receiving the multi-media programs, wherein said subscription service is provided to said receiving device through said distribution network wherein and said satellite antenna comprises a design corresponding to one of said first subject matter theme and said second subject matter theme.

15. The distribution system of claim 14, wherein said first and second subject matter themes comprise at least one of a sports theme, a movie theme, a music theme, and a gaming theme.

16. The distribution system of claim 15, wherein said design comprises at least one of a team logo, a movie screen-shot, a band logo, and a gaming logo.

17. The distribution system of claim 14, wherein said satellite antenna comprises a parabolic surface.

18. The distribution system of claim 17, wherein said design is located on said parabolic surface.

19. The distribution system of claim 18, wherein said design is applied to said parabolic surface by scotch printing.

20. The distribution system of claim 18, wherein said design is applied to said parabolic surface by silk screening.

21. A method for marketing satellite broadcast services, comprising:
providing a set of multi-media programs, wherein a first set of the multi-media programs is available under a basic subscription service with a set of standard subject matter themes and a premier set of the multi-media programs is available under an optional subscription service with at least one specialty subject matter theme, said specialty subject matter theme comprising at least one of a sports theme, a movie theme, a music theme, and a gaming theme;
offering said premier subscription service to a set of subscribers in combination with a corresponding set of satellite antennas, wherein said satellite antennas comprise a set of designs corresponding to at least one of said specialty subject matter themes; said set of designs comprising at least one of a set of team logos for said sports theme, a set of movie screen-shots for said movie theme, a set of band logos for said music theme, and a set of gaming logos for said gaming theme;
receiving a set of subscription selections from said set of subscribers for said premier subscription service and a corresponding selection of said set of designs; and
providing said premier subscription service subscribers with a set of satellite antennas with said corresponding set of selected designs.

22. The method for marketing satellite broadcast services of claim 21, further comprising the step of affixing said set of designs to said set of satellite antennas by scotch printing.

23. The method for marketing satellite broadcast services of claim 21, further comprising the step of affixing said set of designs to said set of satellite antennas by silk screening.
